(19) United States
(12) Patent Application Publication
(10) Pub. No.: US 2026/0366933 A1
(43) Pub. Date: Nov. 19, 2026

(54) PIEZORESISTIVE TACTILE SENSOR

(71) Applicant: Analog Devices, Inc., Wilmington, MA (US)

(72) Inventors: Wenjie Lu, Arlington, MA (US); Dheeraj Virmani, Wilmington, MA (US); Michael Morganto, Cambridge, MA (US); Tao Yu, Needham Heights, MA (US)

(21) Appl. No.: 19/677,914

(22) Filed: May 14, 2026

Related U.S. Application Data
(60) Provisional application No. 63/806,982, filed on May 16, 2025.
(60) Provisional application No. 63/876,671, filed on Sep. 5, 2025.

(51) Int. Cl. G01L 1/18; G01L 5/00

(52) U.S. Cl. CPC G01L 1/18; G01L 5/009

(57) ABSTRACT

Piezoresistive tactile sensors are disclosed. In one aspect, a piezoresistive sensor includes a substrate, a plurality of bottom traces, and a plurality of top traces. The sensor also includes an array of piezoresistive pixels including piezoresistive material coupled between the bottom traces and the top traces. The piezoresistive material of one of the piezoresistive pixels is physically separated from the piezoresistive material of the other piezoresistive pixels. Related methods, systems, and robots are disclosed.

### CROSS REFERENCE TO RELATED APPLICATIONS

This application claims the benefit of priority of U.S. Provisional Application No. 63/806,982, filed May 16, 2025, and titled “FLEXIBLE PIEZORESISTIVE TACTILE SENSOR,” and the benefit of priority of U.S. Provisional Application No. 63/876,671, filed Sep. 5, 2025, and titled “ADVANCED HIGH-DENSITY ISOLATED PIEZORESISTIVE TACTILE SENSOR ON FLEXIBLE SUBSTRATE,” the disclosures of each of which are hereby incorporated by reference herein in its entirety and for all purposes. Any and all applications for which a foreign or domestic priority claim is identified in the Application Data Sheet as filed with the present application are hereby incorporated by reference under 37 CFR 1.57.

### BACKGROUND

### Technical Field

The disclosed technology relates to piezoresistive tactile sensors and related systems and methods.

### Description of Related Technology

Tactile sensors have uses in a variety of applications, including in robotics, prosthetic devices, and consumer electronics. In robotics, tactile sensors are configured to sense a force applied to the sensor, which can be used to provide feedback when manipulating objects. Tactile sensors can be implemented using various sensing technologies.

### SUMMARY OF CERTAIN INVENTIVE ASPECTS

The methods and devices of the described technology each have several aspects, no single one of which is solely responsible for its desirable attributes.

In one aspect, a piezoresistive sensor, comprises: a substrate; a plurality of first traces; a plurality of second traces; and an array of piezoresistive pixels comprising piezoresistive material coupled between the first traces and the second traces, wherein the piezoresistive material of one of the piezoresistive pixels is physically separated from the piezoresistive material of the other piezoresistive pixels.

In some embodiments, the substrate is flexible, and wherein the substrate is folded and an adhesive attaches two sides of the folded substrate together.

In some embodiments, the piezoresistive sensor is configured to detect a location of a force applied to the array of piezoresistive pixels by detecting a change in resistance of a piezoresistive pixel connecting one of the second traces to one of the first traces.

In some embodiments, the first traces and the second traces form a sandwich-crossbar array structure coupled to the array of piezoresistive pixels.

In some embodiments, the piezoresistive sensor further comprises: a plurality of soft structures arranged over the piezoresistive pixels; and a plurality of protection structures arranged over the soft structures.

In some embodiments, the piezoresistive sensor further comprises: a connector area arranged on a single side of the piezoresistive sensor, the connector area configured to electrically connect the first traces and the second traces to an external component.

In some embodiments, the piezoresistive sensor further comprises: a conductive layer formed over the substrate, wherein a plurality of vias are formed in the conductive layer, and wherein the piezoresistive pixels are formed in the vias formed in the conductive layer.

In some embodiments, the substrate comprises a flexible substrate formed of a stretchable material.

In some embodiments, the piezoresistive pixels are formed of a piezoresistive ink, the array of the piezoresistive pixels having a pitch in a range from 0.2 millimeter (mm) to 3 mm between the piezoresistive pixels.

In some embodiments, the array of piezoresistive pixels forms an N x M size array of the piezoresistive pixels, wherein N is greater than or equal to 16.

In some embodiments, the piezoresistive sensor has a dynamic range that extends from 2 millinewton (mN) to 5 megapascals (MPa).

In some embodiments, the piezoresistive sensor further comprises: readout circuitry configured to sequentially scan the array of piezoresistive pixels 102 using row-column multiplexing

Another aspect is a method of manufacturing a piezoresistive sensor, comprising: providing a substrate; forming a plurality of first traces and a plurality of second traces on the substrate; and connecting an array of piezoresistive pixels between the first traces and the second traces, wherein the piezoresistive material of one of the piezoresistive pixels is physically separated from the piezoresistive material of the other piezoresistive pixels after performing the method.

In some embodiments, the substrate comprises a flexible substrate, the method further comprising: folding the flexible substrate to electrically couple the array of piezoresistive pixels between the first traces and the second traces.

In some embodiments, the method further comprises anisotropic conductive film (ACF) bonding the first traces to a connector area formed on one side of the piezoresistive sensor.

In some embodiments, the method further comprises arranging the array of piezoresistive pixels on the substrate by at least dispensing a piezoresistive ink over a portion of the substrate using an inkjet.

In some embodiments, the method further comprises arranging the array of piezoresistive pixels on the substrate by at least printing a printable piezoresistive ink over a portion of the first traces.

In some embodiments, the forming of the first traces, the forming of the second traces, and the connecting of the array of piezoresistive pixels is performed using additive manufacturing.

In some embodiments, the method further comprises arranging the array of piezoresistive pixels on the substrate by at least forming a layer of piezoresistive ink over a portion of the substrate and laser trimming the layer of piezoresistive ink to form the array of piezoresistive pixels, wherein a piezoresistive material of one of the piezoresistive pixels is physically separated from a piezoresistive material of the other piezoresistive pixels.

In some embodiments, the method further comprises arranging the array of piezoresistive pixels on the substrate by at least laser drilling a plurality of vias and dispensing piezoresistive ink into the vias.

In some embodiments, the method further comprises attaching the piezoresistive sensor to an end effector of a robot.

Yet another aspect is a robot with tactile sensing, comprising: an end effector; and a tactile sensor configured to output tactile sensing data, the tactile sensor comprising an array of piezoresistive pixels, the piezoresistive pixels comprising piezoresistive material, wherein the tactile sensor is integrated with the end effector.

In some embodiments, the piezoresistive material of one of the piezoresistive pixels of the array is physically separated from the piezoresistive material of the other piezoresistive pixels of the array.

In some embodiments, the robot further comprises a flexible substrate, the array of piezoresistive pixels being on the flexible substrate, and the tactile sensor conforming to a contour of the end effector.

### BRIEF DESCRIPTION OF THE DRAWINGS

Embodiments of this disclosure will be described, by way of non-limiting example, with reference to the accompanying drawings.

FIGS. 1A-1C illustrate an example flexible piezoresistive tactile sensor at a stage of manufacture in accordance with aspects of this disclosure.

FIGS. 2A-2D illustrate the flexible piezoresistive tactile sensor of FIGS. 1A-1C after being folded to form the sensor in accordance with aspects of this disclosure.

FIGS. 3A-3D illustrate an example embodiment of the flexible piezoresistive tactile sensor in accordance with aspects of this disclosure.

FIGS. 4A-4D illustrate another example flexible piezoresistive tactile sensor in accordance with aspects of this disclosure.

FIGS. 5A-5C illustrate an example flexible piezoresistive tactile sensor in accordance with aspects of this disclosure.

FIG. 6 illustrates an example of a flexible piezoresistive tactile sensor in accordance with aspects of this disclosure.

FIG. 7 illustrates an example of a flexible substrate that can be used in forming a flexible piezoresistive tactile sensor in accordance with aspects of this disclosure.

FIGS. 8A-8E illustrate embodiments of the tactile sensors described herein that can be applied to a robotic manipulator in accordance with aspects of this disclosure.

FIG. 9 illustrates a method of manufacturing a flexible piezoresistive sensor in accordance with aspects of this disclosure.

### DETAILED DESCRIPTION

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings. The headings are provided for convenience only and do not necessarily impact the scope or meaning of the claims.

This disclosure relates to high-density piezoresistive tactile sensors with advanced device structures and manufacturing processes. Embodiments of this disclosure can address several limitations in other designs by consolidating all metal traces onto a single surface, and simplifying routing while maintaining high taxel (tactile pixel) density. Each taxel can be mechanically isolated and capped with a soft material layer and protection layer. A new plugging process for piezoresistive ink into vias can ensure consistent metal-to-ink ohmic contact, uniform ink distribution, and improved device yield. Additionally, the integration of soft, stretchable materials in the device material stack can enhance extreme flexibility and skin-like properties, making the sensor advantageous for applications in robotics, wearables, and tactile sensing. The technology of this disclosure can be cost-effective, scalable, and offers superior performance compared to existing solutions.

In one aspect a flexible piezoresistive sensor includes a flexible substrate, a plurality of bottom traces, a plurality of top traces, and an array of piezoresistive pixels. The piezoresistive pixels include piezoresistive material coupled between the bottom traces and the top traces. The piezoresistive material of one of the piezoresistive pixels is physically separated from the piezoresistive material of the other piezoresistive pixels. Advantageously, this configuration enables a high density tactile sensor while reducing or eliminating cross-talk between pixels.

Another aspect is a method of manufacturing a flexible piezoresistive sensor including providing a flexible substrate with first traces on a first side of the flexible substrate, second traces on a second side of the flexible substrate, and an array of piezoresistive pixels on the first side of the flexible substrate, wherein the first side is opposite the second side. The method also includes folding the flexible substrate to electrically couple the array of piezoresistive pixels between the first traces and the second traces. By folding the substrate, a higher durability sensor can be formed while also simplifying the alignment of the traces with the pixels.

### Tactile Sensing

Tactile sensing is a significant technology for enabling general-purpose robots to interact with their environments in a manner akin to human dexterity. Tactile sensing can be used to provide feedback for robotic systems when grasping objects. For example, tactile sensing can be incorporated into humanoid robots. Tactile sensing is also useful for any type of robot and/or robotic system that has the ability to interact with objects in an environment. Specifically, tactile sensing can improve agility for robotic hands or end effectors.

For robotic dexterous manipulation, the ability to sense and interpret tactile feedback can enable complex tasks, such as grasping delicate objects, adjusting grip force, and interacting with uneven or textured surfaces. Tactile sensors also provide information about the contact between an object and an end effector, which may not be available using other sensors (e.g., the object may be occluded from view of a camera due to the presence of the end effector). In addition, because interacting with objects is a common task for many robots, it is desirable for tactile sensors to be flexible and durable to increase the usable lifetime of the sensor.

Certain robotic systems can lack sufficient tactile feedback, limiting their functionality and versatility. By addressing this gap, tactile sensors can significantly enhance a robot’s ability to perceive and respond to its surroundings, paving the way for advancements in robotics for industries such as manufacturing, healthcare, and service. Aspects of this disclosure provide a novel tactile sensing solution that is both flexible and highly sensitive, making it well-suited for integration into a variety of applications, including robotic fingers and humanoid hands.

Tactile sensing can also be used to treat patients with paralysis to gain or improve grasping capabilities. For patients with paralysis, tactile sensors can improve hand mobility through a brain machine interface.

There are a variety of types of tactile sensing methods, such as capacitive, magnetic, optical, piezoresistive, and vision-based. Certain piezoresistive sensors have low precision and may have issues with cross-talk between sensitive “pixels” of the sensor. Examples of piezoresistive tactile sensors include: single pixel sensors (e.g., having a single piezoresistive sensor), sensor arrays that are physically large (e.g., having a pitch of > 0.5 millimeter), and/or sensor arrays that use non-isolated pixels (e.g., a piezoresistive layer may be shared by multiple pixels), which can introduce mechanical and electrical coupling between sensor pixels.

Aspects of this disclosure relate to improved piezoresistive sensors that can have a high-density piezoresistive pixel array implemented on a flexible substrate. The sensor can include isolated piezoresistive pixels to reduce or eliminate cross-talk (e.g., due to mechanical and/or electrical coupling) between the pixels of the array. In some embodiments, the pixels can be formed using a printable or dispensable piezoresistive material composition. The sensor can also include a sandwich-crossbar array structure assembled through a folding process. Advantageously, the tactile sensor can be used for applications that involve precise tactile sensing, such as robotic fingers and humanoid dexterous hands, where flexibility, high sensitivity and spatial resolution are desirable.

Embodiments of the present disclosure involve forming the tactile sensor on a flexible substrate, which can form the foundation or base of the tactile sensor. As described herein, the flexible sensor can be formed using a sandwich-crossbar configuration, an additive stacked arrangement, a symmetric planar configuration, and/or as a stretchable tactile sensor on the flexible substrate. The flexible substrate can be formed using polyimide, polyethylene terephthalate (PET), stretchable carbonized corn stalk (CCS), or silicone.

Embodiments of the present disclosure provide physical isolation between piezoresistive pixels of the tactile sensor. Depending on the embodiment, the isolation between each pixel’s piezoresistive material can be implemented using via wells, laser trimming, and/or bounded vias. To physically isolate the piezoresistive pixels, each pixel’s piezoresistive material can be separated from the piezoresistive material of its neighbors, advantageously reducing or eliminating mechanical cross-talk. This isolation can enable high density tactile sensors. Without isolation, increasing density typically degrades signal quality of the tactile sensor. According to aspects of this disclosure, isolation can be achieved through high-precision screen printing and/or high-precision dispensing of the piezoresistive ink with micrometer precision and control.

In order to provide a high density of pixels within the tactile sensor, the piezoresistive pixels can be formed using a printable and/or dispensable piezoresistive ink which functions as the sensing material of the tactile sensor. The piezoresistive ink can be formulated such that the ink can be printed, dispensed, and/or plugged to form individual pixels. This can enable the tactile sensors to be manufactured in a mass-production facility, as opposed to in a lab.

Advantageously, the flexible piezoresistive tactile sensors described herein can include isolated piezoresistive pixels to provide precise tactile feedback. The sensor can detect resistance changes through the interaction of top and bottom traces in a matrix configuration of piezoresistive pixels. The flexible piezoresistive tactile sensor can be implemented with a high-density of piezoresistive pixels to enable detailed tactile mapping across the sensor surface. Embodiments of the flexible piezoresistive tactile sensor may also be relatively low noise (e.g., with less cross-talk between pixels) compared to other piezoresistive tactile sensors.

### Examples of Foldable Flexible Piezoresistive Tactile Sensors

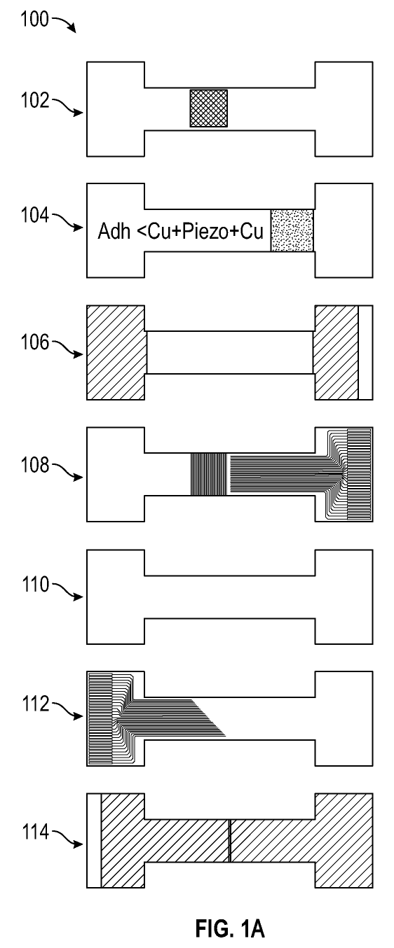

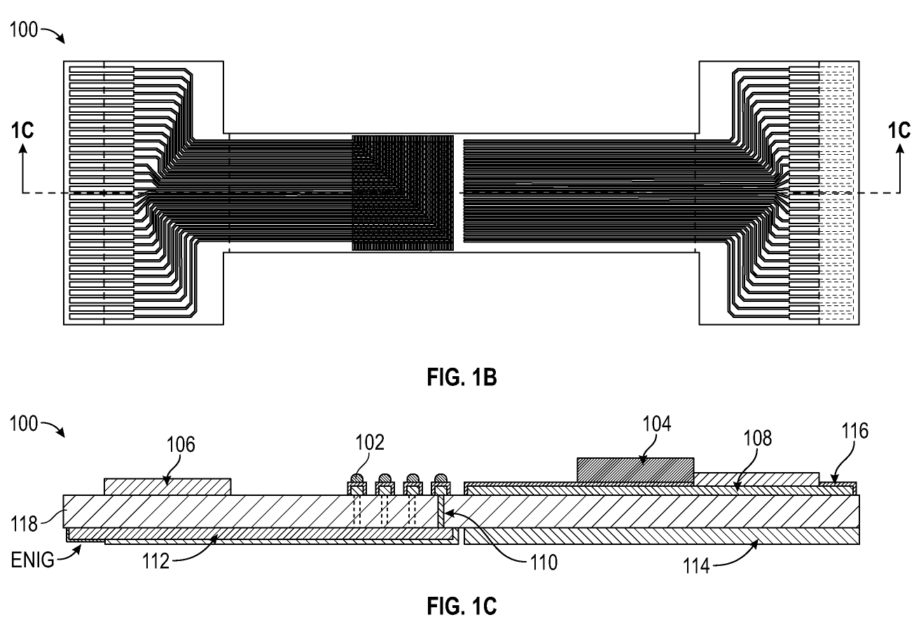

FIGS. 1A-1C illustrate an example flexible piezoresistive tactile sensor 100 at a stage of manufacture in accordance with aspects of this disclosure. In particular, FIG. 1A illustrates the different layers of the sensor 100, FIG. 1B is a top-down view of the sensor 100 including all of the layers, and FIG. 1C is a cross-section along line A-A of the sensor 100 illustrated in FIG. 1B.

The flexible piezoresistive tactile sensor 100 includes a plurality of layers including a piezoresistive layer including a plurality of piezoresistive pixels 102, a top adhesive layer including an adhesive 104, a top coverlay layer including a top coverlay 106, a top trace layer including a plurality of top traces 108, a flexible substrate layer including a plurality of vias 110, a bottom trace layer including a plurality of bottom traces 112, and a bottom coverlay layer including a bottom coverlay 114. The plurality of vias 110 can include formed in a flexible substrate 118. The flexible substrate 118 can be formed of a flexible substrate material, such as polyimide, PET, polyethylene naphthalate (PEN), flexible glass, etc. In some embodiments, the flexible substrate 118 may be about 20-40 micrometers (µm) thick, although aspects of this disclosure are not limited thereto. In some embodiments, the overall stack up thickness for the flexible piezoresistive tactile sensor 100 may be about 100-150 µm thick, although aspects of this disclosure are not limited thereto.

The piezoresistive layer can be formed of a plurality of piezoresistive pixels 102 (tactile pixels may also be referred to as “taxels”) that are physically separated and electrically isolated from each other. By physically separating each piezoresistive pixel 102, any cross-talk between pixels 102 of the sensor 100 can be reduced or eliminated.

In some embodiments, the piezoresistive pixels 102 can be formed by a piezoresistive composition, for example, an ink printing processing that involves printing a printable piezoresistive ink over the top trace layer. One example of the printable piezoresistive ink is 40% ECI 7004HR + 60% NCI 7002. Any other suitable printable piezoresistive ink can be used in accordance with any suitable principles and advantages of this disclosure. For instance, different printable piezoresistive inks can be used or different sensors with different specifications. The piezoresistive inks can include one or more binders configured to adjust the viscosity of the piezoresistive inks such that the piezoresistive inks can be printed, dispensed, or plugged onto the flexible substrate 118. In some embodiments, the piezoresistive pixels 102 can also be formed using other manufacturing techniques, and piezoresistive compositions, such as laser cutting a layer of piezo material, deposition techniques, and forming techniques, etc. In some embodiments, the piezoresistive pixels 102 can be formed to be in a range from about 20-40 µm thick, although aspects of this disclosure are not limited thereto.

The plurality of top traces 108 and the plurality of bottom traces 112 can be formed as conductive traces. The conductive traces can be formed using various techniques, including printing metal layers using a printable conductive material or plating of the conductive traces. In some embodiments, the conductive traces can be formed to be in a range from about 10 µm to 21 µm thick, although aspects of this disclosure are not limited thereto.

The top coverlay 106 and the bottom coverlay 114 can be configured to cover the top traces 108 and the bottom traces 112 to protect the top and bottom traces 108, 112 from the environment. In some embodiments, the adhesive 104 can be formed to be about 20-30 µm thick and the top and bottom coverlay layers can be formed to be in a range from about 15-25 µm thick, although aspects of this disclosure are not limited thereto.

In some embodiments, portions of the top and bottom traces 108, 112 may be plated using an electroless nickel immersion gold (ENIG) plating. The ENIG plating can improve durability of the sensor 100. In some embodiments, the ENIG plating can include a Ni layer with a thickness of about 1-4 µm and an Au layer with a thickness in a range from about .02-.07 µm, although aspects of this disclosure are not limited thereto. Other suitable methods can be used for the plating, such as electrolytic Ni/Au (which may be more reliable for certain applications), organic solderability preservative (OSP) coating (e.g., for consumer applications), and/or electroless nickel / electroless palladium / immersion gold (ENEPIG).

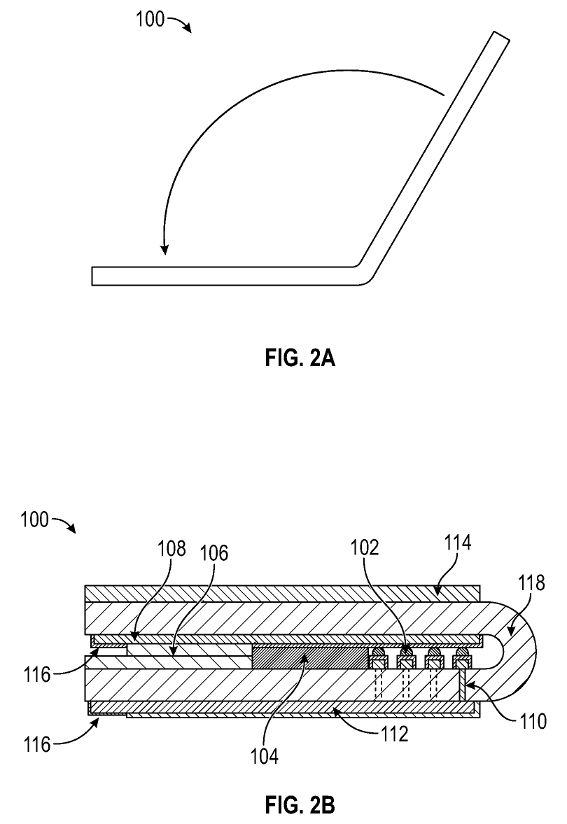

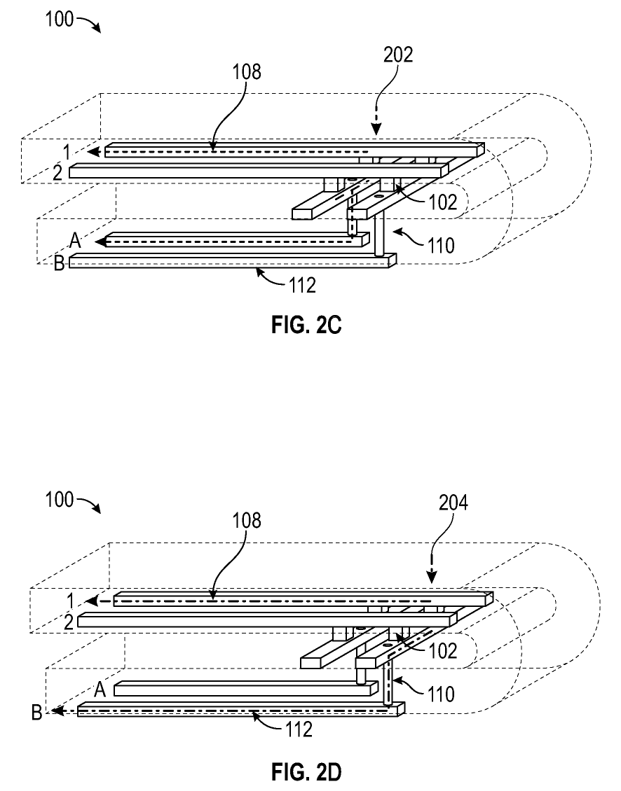

FIGS. 2A-2D illustrate the flexible piezoresistive tactile sensor 100 of FIGS. 1A-1C after being folded to form the sensor 100 in accordance with aspects of this disclosure. In particular, FIG. 2A shows how the flexible piezoresistive tactile sensor 100 can be folded, FIG. 2B shows the flexible piezoresistive tactile sensor after folding is completed, FIG. 2C shows the measurement of a first force 202 applied at a first location of the sensor 100, and FIG. 2D shows the measurement of a second force 204 applied at a second location of the sensor 100.

As shown in FIGS. 2A-2D, after the flexible piezoresistive tactile sensor 100 is folded, the top traces 108 are electrically coupled to a line of the piezoresistive pixels 102. FIGS. 2A-2D illustrate a simplified example with an array of four pixels connected to two top traces 1, 2 and two bottom traces A, B. When the first force 202 is applied to the top left pixel, the resistance between the top trace 1 and the bottom trace A will be changed, which can be detected to identify the location and amplitude of the first force 202. For example, when the first force 202 is applied at the location illustrated in FIG. 2C, a resistance change at the corresponding piezoresistive pixel 102 will be detected between the top trace 1 and the bottom trace A.

Similarly, when the second force 204 is applied to the top right pixel, the resistance between the top trace 1 and the bottom trace B will be changed, which can be detected to identify the location and amplitude of the second force 204. For example, when the second force 204 is applied at the location illustrated in FIG. 2D, a resistance at the corresponding piezoresistive pixel 102 will be detected between the top trace 1 and the bottom trace B.

The connections between the top traces 108, piezoresistive pixels 102, and the bottom traces 112 can form a sandwich-crossbar array structure. The top traces 108 located below the piezoresistive pixels 102 can be connected to the bottom traces 112 by way of the vias 110. In some embodiments, the vias 110 can be formed as plated-through-hole (PTH) connections, forming a matrix arrangement for resistance change detection of the piezoresistive pixels 102. This structure enables higher-density sensing, for example, with a pitch in a range from 0.2 millimeters (mm) to 3 mm between pixels 102. In some embodiments, the sandwich-crossbar array structure includes perpendicular top and bottom conductive traces with piezoresistive pixels arranged at each intersection between the conductive traces to form an N×M matrix. The N×M matrix of piezoresistive pixels is addressable using N+M number of conductive traces.

In some embodiments, the flexible piezoresistive tactile sensor 100 can include readout circuitry configured to sequentially scan the array of piezoresistive pixels 102 using row-column multiplexing. The readout circuitry can include a row driver configured to sequentially apply an excitation voltage or current to each of the top traces 108 (or bottom traces 112), one row at a time. For each active row, a column multiplexer can sequentially connect each of the bottom traces 112 (or top traces 108) to a measurement circuit. The measurement circuit can include a transimpedance amplifier configured to convert a current flowing through the piezoresistive pixel 102 at the intersection of the active row and selected column into a voltage signal proportional to the conductance of the piezoresistive pixel 102. The voltage signal can be digitized by an analog-to-digital converter (ADC). By scanning all rows and columns in sequence, the readout circuitry can acquire a complete frame of resistance (or conductance) measurements across the entire N x M array of piezoresistive pixels 102. In some embodiments, the row driver can include a shift register, and the column multiplexer can include an analog multiplexer (e.g., a 32:1 multiplexer). In some embodiments, the readout circuitry can be configured to scan the full array at a frame rate of at least 100 Hz, at least 240 Hz, or at least 1000 Hz. In some embodiments, the measurement circuit can further include a programmable gain element, such as a digital potentiometer, configured to adjust the sensitivity of the measurement circuit to accommodate piezoresistive pixels having different baseline resistance ranges.

With reference to FIGS. 1A-2D, a method of manufacturing a flexible piezoresistive tactile sensor 100 can include providing a flexible substrate 118 and forming a plurality of layers on the top and bottom of the flexible substrate 118. Forming the plurality of layers can include forming a plurality of bottom traces 112 on a bottom of the flexible substrate 118, forming a plurality of top traces 108 on a top of the flexible substrate 118, forming an array of piezoresistive pixels 102 on the top of the flexible substrate 118. In some embodiments, forming the array of piezoresistive pixels 102 can include printing a printable piezoresistive ink over a portion of the plurality of top traces 108. In some embodiments, each of the layers illustrated in FIG. 1 (other than the flexible substrate layer) can be formed on the flexible substrate 118.

The method can also include folding the flexible substrate 118 to electrically couple the array of piezoresistive pixels 102 between the bottom traces 112 and the top traces 108. By folding the sensor 100 during assembly, the sensor 100 can have a compact form factor with increased structural integrity.

In some embodiment, the method can also involve forming a well, which can include using a solder resist, for each of the piezoresistive pixels 102. The wells can maintain the volume available for each pixel 102 while reducing any variation between the volume of the pixels 102.

The flexible substrate 118 can flex and/or bend while maintaining desirable performance and functionality. The flexible substrate can have a bend radius of at least 30°, at least 45°, at least 90°, or at least 180°.

In some embodiments, folding the flexible substrate 118 can involve using one or more alignment features to align the top and bottom portions of the flexible substrate 118 as they are attached to each other. In some embodiments, the piezoresistive pixels 102 can be used as alignment features, while in some other embodiments, dedicated alignment features (e.g., registration marks) can be added to the top and/or bottom portions of the flexible substrate 118. The method can involve using a vision system (e.g., a camera) to ensure that the alignment features are aligned as the flexible substrate 118 is folded.

Advantageously, the folding process can produce a tactile sensor 100 that has better durability and/or a reduced chance of delamination compared to some other tactile sensors. The folding process is also a comparatively simple process compared to certain other techniques for sandwiching separately manufactured layers. In addition, aspects of the disclosed sensor 100 include two layers which are folded together, while sensors 100 using sandwiched layers can include three or more layers sandwiched together in some other applications.

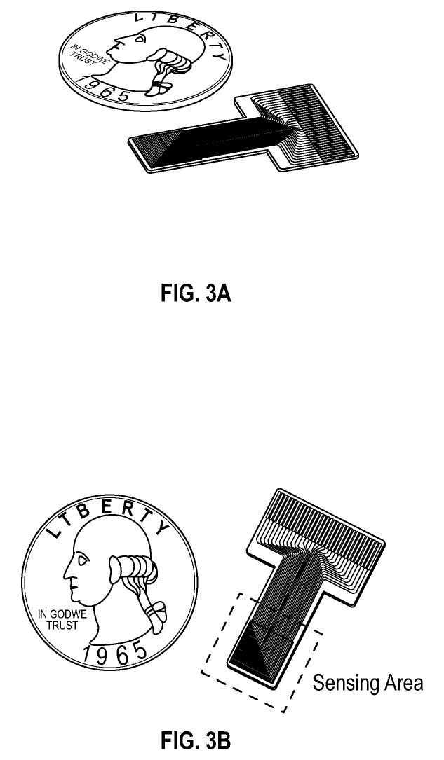

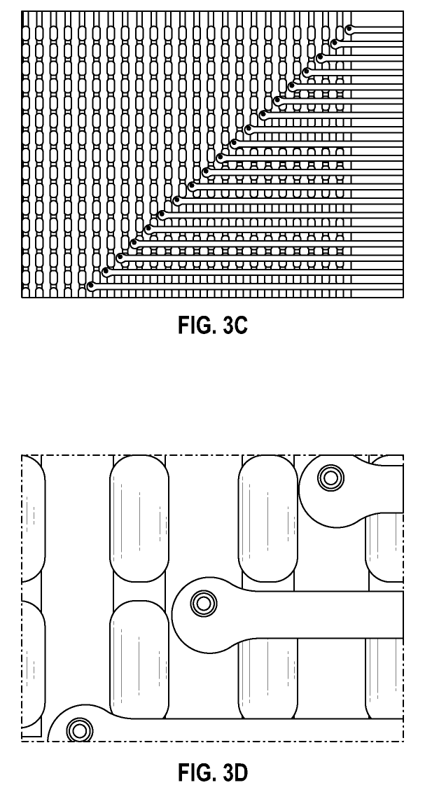

FIGS. 3A-3D illustrate an example embodiment of the flexible piezoresistive tactile sensor in accordance with aspects of this disclosure. FIGS. 3A and 3B show the scale of this embodiment of the sensor compared to a quarter. In FIG. 3B, the sensing area of the sensor is indicated. FIGS. 3C and 3D show a close up of the traces within the sensing area of the sensor.

In some embodiments, the flexible piezoresistive tactile sensor can include an array of 1024 pixels with a 200 µm resolution. This resolution is above known commercially available piezoresistive sensors. The piezoresistive tactile sensor can also be highly flexible with a bend radius of about 180 degrees.

Advantageously, the design of the flexible piezoresistive tactile sensor enables the sensor to be manufactured using a reel-to-reel high-volume process. For example, embodiments can involve using ink jet and/or screen print technology to create individual fine piezoresistive pixels which can be implemented in the reel-to-reel high-volume process. Due to the overall flexibility of the flexible piezoresistive tactile sensor, the sensor can be used as a skin-like flex-based sensor, which can be installed on the end effector of a robot (e.g., on the finger tips, palm, arms, etc. of a robot).

The flexible piezoresistive tactile sensors of this disclosure can have a number of other advantages, including one or more of the piezoresistive sensors can be very cost efficient, highly durable, scalable (e.g., the size of the overall sensor and/or resolution can be easily adjusted), and the sensor can be embodied in a skin like form factor. Due to the use of piezoresistive sensing technology, the sensor can detect the location of a force without significant deformation of the sensor. In addition, the isolation of the individual piezoresistive pixels can reduce or elimination cross-talk between pixels.

### Additional Examples of Foldable Flexible Piezoresistive Tactile Sensors

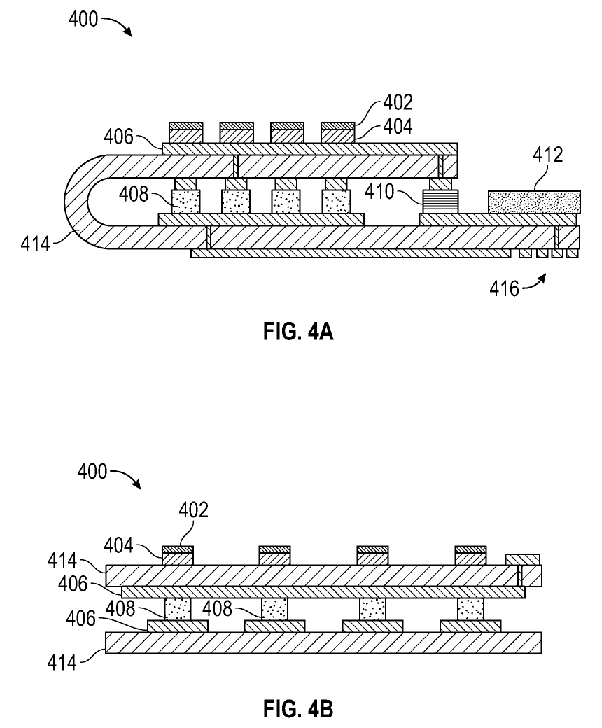

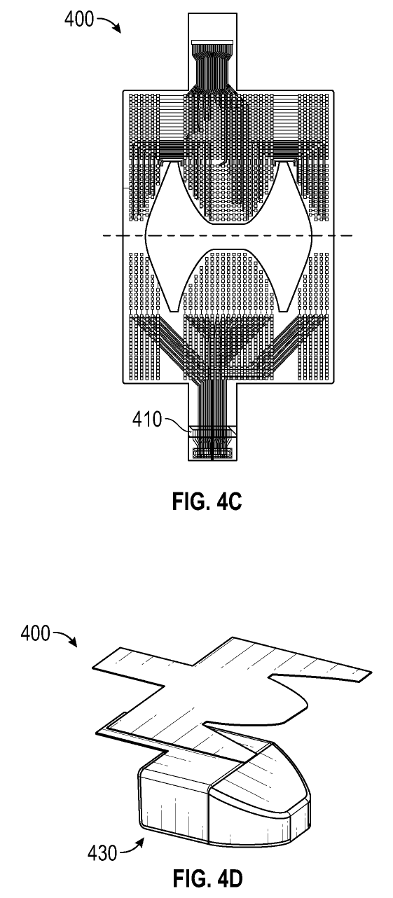

FIGS. 4A-4D illustrate another example flexible piezoresistive tactile sensor 400 in accordance with aspects of this disclosure. In particular, FIG. 4A illustrates a cross-section of the flexible piezoresistive tactile sensor 400 along a first direction and FIG. 4B illustrates a cross-section of the flexible piezoresistive tactile sensor 400 along a second direction. FIG. 4C provides a plan view of the flexible piezoresistive tactile sensor 400 prior to folding and FIG. 4D illustrates how the flexible piezoresistive tactile sensor 400 can be applied to an end effector 430 of a robotic actuator. For example, the flexible piezoresistive tactile sensor 400 can be applied to the 3-dimensional (3D) fingertip of a robot dexterous hand.

As shown in FIGS. 4A-4D, the flexible piezoresistive tactile sensor 400 includes a plurality of protection structures 402 in a protection layer, a plurality of soft strictures 404 in a soft layer, a plurality of conductive traces 406 in a conductive layer, a plurality of piezoresistive pixels 408, an anisotropic conductive film (ACF) 410, a stiffener 412, a flexible substrate 414, and a connector area 416.

The ACF 410 is configured to bond conductive traces 406 of the conductive layers together. The use of the ACF 410, together with forming the piezoresistive pixels 408 using plugging or ink dispensing can enable the formation of the connector area 416 on a single side of the flexible piezoresistive tactile sensor 400. The connector area 416 is configured to connect the conductive traces 406 to an external component. This formation of connector area 416 on a single side of the flexible piezoresistive tactile sensor 400 can simplify the process of connecting the flexible piezoresistive tactile sensor 400 to external components/devices since multiple connection points are not involved.

Consolidating the electrical connections to one side of the substrate can advantageously simplify routing and reduce or eliminate a scaling bottleneck that other dual-connector designs may involve. FIGS. 4A-4D show how ACF 410 bonding bridges the folded halves to bring all signals to one connector area 416 with the stiffener 412.

As shown in FIGS. 4A-4D, each of the protection structures 402 and each of the soft structures 404 can be formed over a corresponding one of the piezoresistive pixels 408. The protective layer and the soft layer can be configured to function as a protective skin layer as well as to provide grip/friction when contacting an object.

In some embodiments, the flexible piezoresistive tactile sensor 400 can further include an overmold layer formed over the array of piezoresistive pixels 408. For example, the overmold layer can be formed over the protection structures 402 and the soft structures 404. The overmold layer can include an elastomeric material configured to conform to a surface of an end effector and to provide a compliant contact surface for grasping objects. The elastomeric material can include silicone, polyurethane, thermoplastic polyurethane (TPU), or other suitable elastomeric material. In some embodiments, the overmold layer can have a Shore A hardness in a range from about 20A to about 50A. Advantageously, the overmold layer can increase the contact area between the flexible piezoresistive tactile sensor 400 and an object being grasped, thereby improving passive grasping stability and grip friction. The overmold layer can also function as a protective wear layer, shielding the piezoresistive pixels 408 and conductive traces 406 from abrasion, contamination, and electrostatic discharge during repeated use. In some embodiments, the overmold layer can have a thickness in a range from about 0.5 mm to about 2 mm. The thickness and hardness of the overmold layer can be selected to balance grip compliance against force transmission fidelity to the underlying piezoresistive pixels 408, as a thicker or softer overmold layer may attenuate spatial resolution of the tactile sensor.

In some embodiments, the piezoresistive pixels 408 can be isolated by forming a layer of piezoresistive material and laser trimming the piezoresistive material layer to enable individual control of the piezoresistive pixels 408.

According to some embodiments, contact between the piezoresistive pixels 408 and the conductive traces can be enhanced by providing inter-column thermal-sensitive adhesive (TSA) and/or pressure-sensitive adhesive (PSA) adhesive layers arranged between the piezoresistive pixels 408. In some embodiments, conductive adhesion layer(s) can be arranged on top or below the piezoresistive pixels 408 to enhance the contact between the piezoresistive pixels 408 and the conductive traces. The adhesive layers arranged between piezoresistive pixels 408 can be used in combination with the conductive adhesion layer(s) can be arranged on top or below the piezoresistive pixels 408 in some embodiments.

The flexible piezoresistive tactile sensor 400 can be used to form both flat tactile sensors with regular (e.g., rectangular) shapes for gripper fingers as well as tactile sensors that can cover the 3D fingertip of a robot dexterous hand.

### Examples of Flexible Piezoresistive Tactile Sensors Having a Stacked Structure

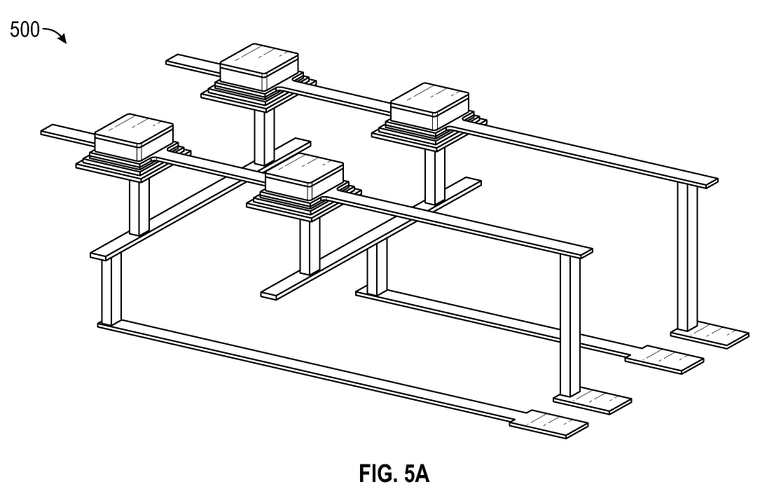

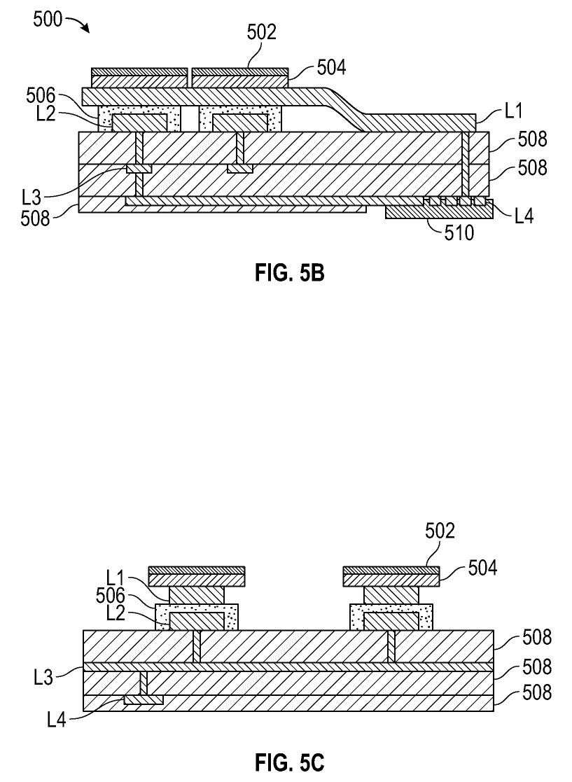

FIGS. 5A-5C illustrate an example flexible piezoresistive tactile sensor 500 in accordance with aspects of this disclosure. In particular, FIG. 5A provides a view of the configuration of a plurality of traces included in the tactile sensor 500, FIG. 5B provides a cross-sectional view in the direction of a first set of the traces, and FIG. 5C provides a cross-sectional view in the direction of a second set of the traces.

As shown in FIGS. 5A-5C, the flexible piezoresistive tactile sensor 500 includes a plurality of protection structures 502 in a protection layer, a plurality of soft structures 504 in a soft layer, a plurality of piezoresistive pixels 506, a plurality of flexible substrate layers 508, a connector area 510, and a plurality of conductive traces formed in a plurality of conductive trace layers L1, L2, L3, and L4. Flexible substrate layers 508 can be dielectric layers.

In some embodiments, the flexible piezoresistive tactile sensor 500 can be formed with a stacked sandwich structure that enables the flexible piezoresistive tactile sensor 500 to be manufactured using additive manufacturing. When compared to some other tactile sensors, embodiments of the flexible piezoresistive tactile sensor 500 manufactured using additive manufacturing can have a fewer number of layers, enabling the flexible piezoresistive tactile sensor 500 to be formed thinner and to be more flexible.

Advantageously, by using additive manufacturing to manufacture the flexible piezoresistive tactile sensor 500, a top flexible substrate layer formed above the piezoresistive pixels 506 can be removed from the flexible piezoresistive tactile sensor 500.

Similar to the embodiment of FIGS. 4A-4D, the flexible piezoresistive tactile sensor 500 can use a single sided connector area 510. This can be enabled in similar ways to the flexible piezoresistive tactile sensor 400, including by using plugging, ACF bonding, and/or conductive ink dispensing.

The flexible piezoresistive tactile sensor 500 can also use the plurality of protection structures 502 and plurality of soft structures 504, for example, similar to as described in connection with the flexible piezoresistive tactile sensor 400 of FIGS. 4A-4D. In some embodiments, the flexible piezoresistive tactile sensor 500 can also include an overmold layer as discussed in connection with the flexible piezoresistive tactile sensor 400 of FIGS. 4A-4D.

In some embodiments, the piezoresistive pixels 506 can be isolated by forming a layer of piezoresistive material and laser trimming the piezoresistive material layer to enable individual control of the piezoresistive pixels 506. The flexible piezoresistive tactile sensor 500 can also use inter-column adhesive layers and/or conductive adhesion layer(s), for example, similar to as described in connection with the flexible piezoresistive tactile sensor 400 of FIGS. 4A-4D.

### Examples of Flexible Planar Piezoresistive Tactile Sensors

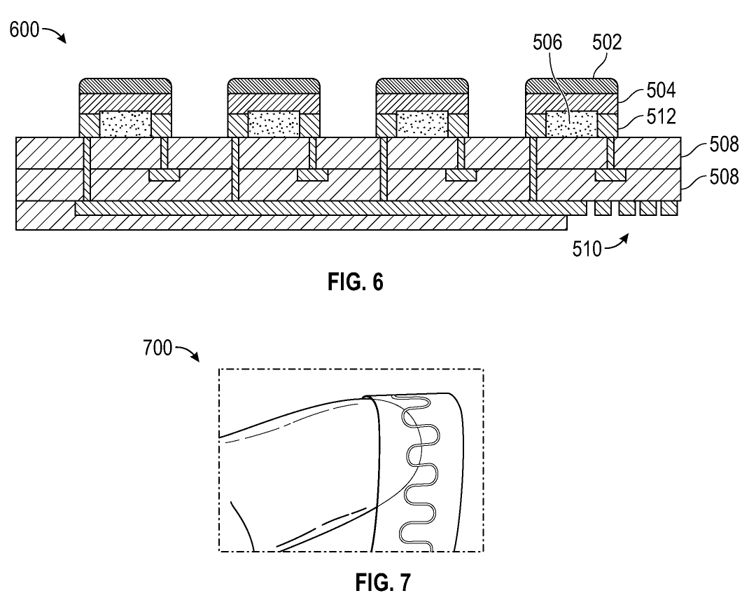

FIG. 6 illustrates an example of a flexible piezoresistive tactile sensor 600 in accordance with aspects of this disclosure. The flexible piezoresistive tactile sensor 600 includes a plurality of protection structures 502, a plurality of soft structures 504, a plurality of piezoresistive pixels 506, a plurality of flexible substrate layers 508, a connector area 510, and a plurality of conductive traces 512. Like reference numerals in FIG. 6 indicate identical or functionally similar elements to those used in one or more other figures.

In some embodiments, the flexible piezoresistive tactile sensor 600 can be formed as a generally symmetric planar sensor using a printing/plugging process. In particular, the flexible piezoresistive tactile sensor 600 can have a symmetrical metal-to-piezo ohmic contact with a lower contact resistance.

By using a printing or plugging process to form the piezoresistive pixels 506 using a piezoresistive ink, the piezoresistive pixels 506 can be formed with a higher uniformity than piezoresistive pixels 506 formed using some other manufacturing techniques.

In some embodiments, the plugging process can involve forming a layer of the conductive material and forming holes or vias in the conductive material. In some embodiments, the diameters of the holes can be formed to be substantially uniform across the entire sensing area using an ultra-violet (UV) yttrium aluminum garnet (Yag) or similar laser process. The volume of piezoresistive ink material dispensed into the holes can be controlled better due to the substantially uniform hole boundaries formed using the laser process. Thus, the uniformity of the piezoresistive pixels 506 can be improved.

In the embodiment of FIG. 6, the piezoresistive pixels 506 can be separated from the majority of the conductive traces 512 by forming the conductive traces 512 within dielectric layers forming the plurality of flexible substrate layers 508. With the conductive traces 512 buried below the piezoresistive pixels 506, the flexible piezoresistive tactile sensor 600 can provide better tactile measurement performance.

### Examples of Flexible Piezoresistive Tactile Sensors Formed on Ultra-Flexible Materials

FIG. 7 illustrates an example of a flexible substrate 700 that can be used in forming a flexible piezoresistive tactile sensor in accordance with aspects of this disclosure. In some embodiments, the flexible piezoresistive tactile sensors described herein can be formed on a flexible substrate 700 formed of a stretchable, ultra-flexible material. When the flexible tactile sensor is formed on a stretchable, soft material, the tactile sensor can be embodied as a skin-like device that is thin, stretchable, and/or 3D conformable.

To fabricate a tactile sensor on a stretchable material, the layers of the tactile sensor can be fabricated via ink printing and/or dispensing on the stretchable, soft material. Examples of materials that can be used for the stretchable material include: Beyolex, silicone, Sylgard 184 silicone elastomer, Beyolex Thermosetting stretchable film, Thermoplastic Polyurethane (TPU), polyimide (PI), etc. In some embodiments, the stretchable material may have a thickness of approximately 25 µm or 50 µm.

Advantageously, tactile sensors formed using a flexible substrate 700 formed of a stretchable material can enable the tactile sensors to be bent up to 180 degrees while still retaining functionality. Certain materials, such as TPU, can be sufficiently stretchable to conform to many different geometries. When PI is used, the tactile sensor can be configured to withstand relatively high temperature (e.g., up to 120°C).

### Examples of Flexible Piezoresistive Tactile Sensors Formed on Ultra-Flexible Materials

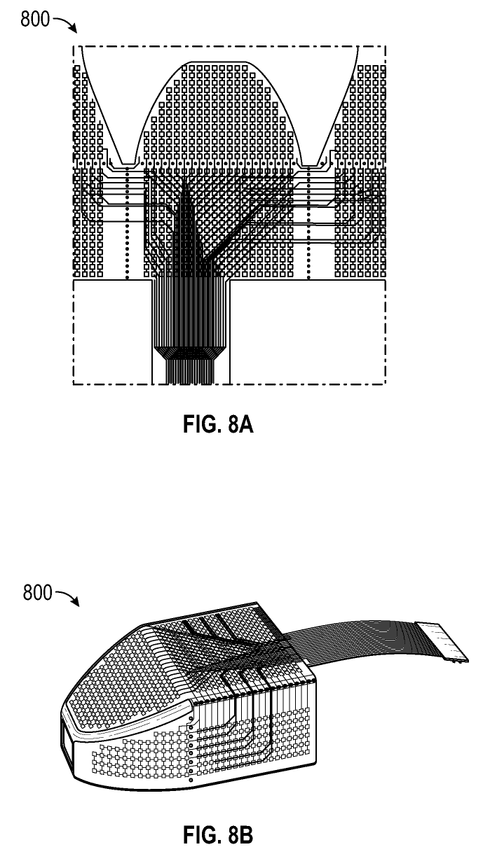

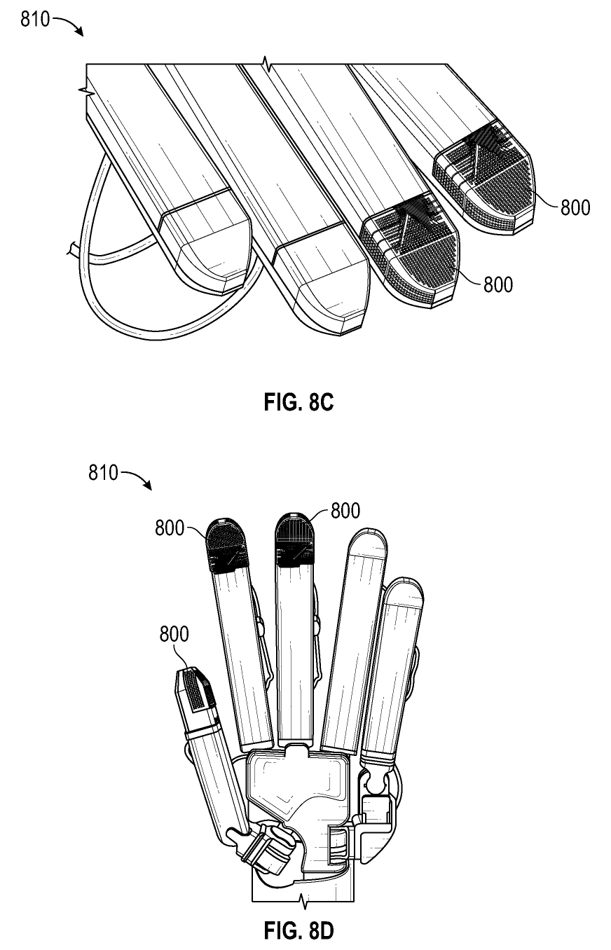

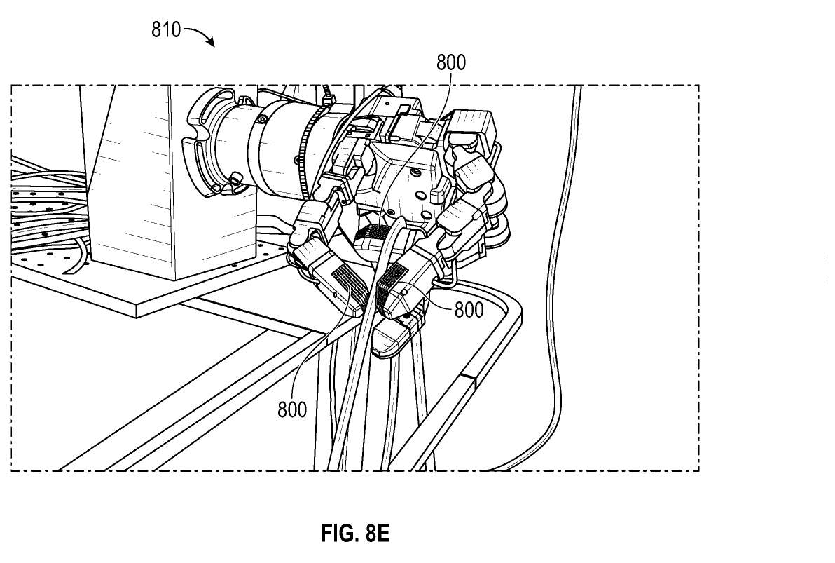

FIGS. 8A-8E illustrate embodiments of the tactile sensors described herein that can be applied to a robotic manipulator in accordance with aspects of this disclosure. FIG. 8A illustrates a tactile sensor 800 prior to being shaped to fit a robotic manipulator. FIG. 8B illustrated a tactile sensor 800 that has been shaped to fit a robotic manipulator. FIG. 8C illustrates a first embodiment of a robotic manipulator 810 with two tactile sensors 800 attached to fingertips of the robotic manipulator 810. FIG. 8D illustrates a second embodiment of a robotic manipulator 810 with three tactile sensors 800 attached to fingertips of the robotic manipulator 810. FIG. 8E illustrates a third embodiment of a robotic manipulator 810 using two tactile sensors 800 to grasp an object. The robotic manipulator 810 can include a robotic dexterous hand. In the example of FIG. 8E, the dexterous hand is tracing an ethernet cable, which is enabled by the tactile sensors 800 described herein.

Advantageously, embodiments of the present disclosure provide a tactile sensor having a comparatively large dynamic range. For example, the tactile sensor can have a dynamic range that extends from less than 2 millinewton (mN) to more than 5 megapascals (MPa). The tactile sensor includes a plurality of tactile pixels (or taxels) that are configured to generate a variable resistance in response to pressures applied to the tactile pixels. In contrast, capacitive sensors have a low dynamic range since capacitive sensors can quickly saturate as the applied pressures increase. This can be because capacitive sensors have a hard stop at which the sensor cannot be compressed any further which is due to the mechanical properties of the elastomer layer being compressed.

Embodiments of the disclosed tactile sensor are also scalable, allowing the tactile sensor to be manufactured to fit many different shapes and form factors. Using a printable piezoresistive ink to form an array of piezoresistive pixels can allow the pixels to be manufactured using screen printing. Since screen printing can be performed reel-to-reel, this enables the tactile sensors to be manufactured in a mass-production facility.

### Examples Methods of Manufacturing Flexible Piezoresistive Tactile Sensors

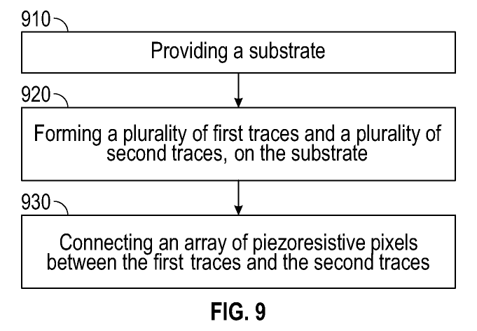

FIG. 9 illustrates a method 900 of manufacturing a piezoresistive sensor in accordance with aspects of this disclosure. The method 900 can be used to manufacture the flexible piezoresistive sensor 100 of FIGS. 1A-2D, the flexible piezoresistive tactile sensor 400 of FIGS. 4A-4D, the flexible piezoresistive tactile sensor 500 of FIGS. 5A-5C, or the flexible piezoresistive tactile sensor 600 of FIG. 6.

At block 910, the method 900 involves providing a substrate.

At block 920, the method 900 involves forming a plurality of first traces and a plurality of second traces, on the substrate.

At block 930, the method 900 involves connecting an array of piezoresistive pixels between the first traces and the second traces.

In some embodiments, the substrate includes a flexible substrate, the method 900 further involves folding the flexible substrate to electrically couple the array of piezoresistive pixels between the first traces and the second traces.

For example, folding the flexible substrate can include forming trace layers on opposite sides of a single flexible substrate, and then folding the flexible substrate to sandwich the piezoresistive pixels. This can eliminate the need to separately align and laminate individually manufactured layers — a process that typically becomes exponentially more difficult at finer pixel pitch.

In some embodiments, the method 900 further involves arranging the array of piezoresistive pixels on the substrate by at least dispensing a piezoresistive ink over a portion of the substrate using an inkjet.

In some embodiments, the method 900 further involves arranging the array of piezoresistive pixels on the substrate by at least printing a printable piezoresistive ink over a portion of the first traces.

For example, the printable piezoresistive ink can be printed using inkjet or screen printing to create individual isolated pixels at fine pitch (e.g., at a pitch of as low as 200 µm). This is more scalable for high density than cutting or etching bulk piezoresistive material.

In some embodiments, the method 900 further involves arranging the array of piezoresistive pixels on the substrate by at least forming a piezoresistive composition over a portion of the first traces.

In some embodiments, the method 900 further involves arranging the array of piezoresistive pixels on the substrate by at least depositing a piezoresistive composition over a portion of the first traces.

In some embodiments, the forming of the first traces, the forming of the second traces, and the arranging of the array of piezoresistive pixels is performed using additive manufacturing.

In some embodiments, the method 900 further involves arranging the array of piezoresistive pixels on the substrate by at least forming a layer of piezoresistive ink over a portion of the substrate and laser trimming the layer of piezoresistive ink to form the array of piezoresistive pixels, wherein the piezoresistive material of one of the piezoresistive pixels is physically separated from the piezoresistive material of the other piezoresistive pixels.

For example, post-fabrication laser trimming can be used to isolate individual piezoresistive pixels, enabling individual control even if the initial fabrication creates a continuous layer.

In some embodiments, the method 900 further involves arranging the array of piezoresistive pixels on the substrate by at least laser drilling a plurality of vias and dispensing piezoresistive ink into the vias.

This laser drilling may be referred to as plugging which includes plugging the piezoresistive ink into the laser-drilled vias. The via hole diameters can be formed to be substantially uniform across the entire sensing area using an UV YAG laser or similar laser process. The ink volume in each hole is bounded by the hole walls, providing better uniformity than open-surface printing. This ensures consistent metal-to-ink ohmic contact and uniform ink distribution — both improving for yield at high density.

Various embodiments for manufacturing the piezoresistive sensor are compatible with high-volume reel-to-reel manufacturing with a customized foldable design. This can enable high-volume manufacturing of the piezoresistive sensors.

### Applications, Terminology, and Conclusion

Piezoresistive tactile sensing systems disclosed herein can be implemented in any suitable application that can benefit from tactile sensing. Example applications include, but are not limited to, robotics and treating paralysis.

In the embodiments described above, sensors, circuits, systems, and methods for piezoresistive tactile sensing are described in connection with particular embodiments. It will be understood, however, that the principles and advantages of the embodiments can be used for any other suitable sensors, circuits, systems, and methods with a piezoresistive tactile sensing system.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Thus, although the various schematics shown in the figures depict example arrangements of elements and components, additional intervening elements, devices, features, or components may be present in an actual embodiment (assuming that the functionality of the depicted circuits is not adversely affected). Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the embodiments provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments of the inventions have been described, these embodiments have been presented by way of example only, and are not intended to limit the scope of the disclosure. Indeed, the novel circuits, methods, and systems described herein may be embodied in a variety of other forms. Furthermore, various omissions, substitutions and changes in the form of the circuits, methods, apparatus and systems described herein may be made without departing from the spirit of the disclosure. For example, while the disclosed embodiments are presented in given arrangements, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure. Accordingly, the scope of the present inventions is defined by reference to the claims.

Although the claims presented here are in single dependency format for filing at the USPTO, it is to be understood that any claim may depend on any preceding claim of the same type except when that is clearly not technically feasible.

What is claimed is:

1. A piezoresistive sensor, comprising:
a substrate;
a plurality of first traces;
a plurality of second traces; and
an array of piezoresistive pixels comprising piezoresistive material coupled between the first traces and the second traces, wherein the piezoresistive material of one of the piezoresistive pixels is physically separated from the piezoresistive material of the other piezoresistive pixels.

2. The piezoresistive sensor of claim 1, wherein the substrate is flexible, and wherein the substrate is folded and an adhesive attaches two sides of the folded substrate together.

3. The piezoresistive sensor of claim 1, wherein the first traces and the second traces form a sandwich-crossbar array structure coupled to the array of piezoresistive pixels.

4. The piezoresistive sensor of claim 1, further comprising:
a plurality of soft structures arranged over the piezoresistive pixels; and
a plurality of protection structures arranged over the soft structures.

5. The piezoresistive sensor of claim 1, further comprising:
a connector area arranged on a single side of the piezoresistive sensor, the connector area configured to electrically connect the first traces and the second traces to an external component.

6. The piezoresistive sensor of claim 1, further comprising:
a conductive layer formed over the substrate,
wherein a plurality of vias are formed in the conductive layer, and
wherein the piezoresistive pixels are formed in the vias formed in the conductive layer.

7. The piezoresistive sensor of claim 1, wherein the piezoresistive pixels are formed of a piezoresistive ink, the array of the piezoresistive pixels having a pitch in a range from 0.2 millimeter (mm) to 3 mm between the piezoresistive pixels.

8. The piezoresistive sensor of claim 1, wherein the array of piezoresistive pixels forms an N x M size array of the piezoresistive pixels, wherein N is greater than or equal to 16.

9. The piezoresistive sensor of claim 1, wherein the piezoresistive sensor has a dynamic range that extends from 2 millinewton (mN) to 5 megapascals (MPa).

10. The piezoresistive sensor of claim 1, further comprising:
readout circuitry configured to sequentially scan the array of piezoresistive pixels using row-column multiplexing.

11. A method of manufacturing a piezoresistive sensor, comprising:
providing a substrate;
forming a plurality of first traces and a plurality of second traces on the substrate; and
connecting an array of piezoresistive pixels between the first traces and the second traces, wherein the piezoresistive material of one of the piezoresistive pixels is physically separated from the piezoresistive material of the other piezoresistive pixels after performing the method.

12. The method of claim 11, wherein the substrate comprises a flexible substrate, the method further comprising:
folding the flexible substrate to electrically couple the array of piezoresistive pixels between the first traces and the second traces.

13. The method of claim 11, further comprising:
anisotropic conductive film (ACF) bonding the first traces to a connector area formed on one side of the piezoresistive sensor.

14. The method of claim 11, further comprising arranging the array of piezoresistive pixels on the substrate by at least printing a printable piezoresistive ink over a portion of the first traces.

15. The method of claim 11, wherein the forming of the first traces, the forming of the second traces, and the connecting of the array of piezoresistive pixels is performed using additive manufacturing.

16. The method of claim 11, further comprising arranging the array of piezoresistive pixels on the substrate by at least forming a layer of piezoresistive ink over a portion of the substrate and laser trimming the layer of piezoresistive ink to form the array of piezoresistive pixels, wherein a piezoresistive material of one of the piezoresistive pixels is physically separated from a piezoresistive material of the other piezoresistive pixels.

17. The method of claim 11, further comprising arranging the array of piezoresistive pixels on the substrate by at least laser drilling a plurality of vias and dispensing piezoresistive ink into the vias.

18. A robot with tactile sensing, comprising:
an end effector; and
a tactile sensor configured to output tactile sensing data, the tactile sensor comprising an array of piezoresistive pixels, the piezoresistive pixels comprising piezoresistive material,
wherein the tactile sensor is integrated with the end effector.

19. The robot of claim 18, wherein the piezoresistive material of one of the piezoresistive pixels of the array is physically separated from the piezoresistive material of the other piezoresistive pixels of the array.

20. The robot of claim 19, further comprising a flexible substrate, the array of piezoresistive pixels being on the flexible substrate, and the tactile sensor conforming to a contour of the end effector.
